(19) United States
(12) Patent Application Publication
(10) Pub. No.: US 2009/0130254 A1
(43) Pub. Date: May 21, 2009

(54) Process for Removal of Toxic or Undersirable Polyhalogenated Compounds in Beverages, Especially in Wine

(75) Inventors: Laurent Vuillaume, Vonnas (FR); Gerard Michel, Quetigny (FR)

Correspondence Address: YOUNG & THOMPSON, 209 Madison Street, Suite 500, ALEXANDRIA, VA, 22314, US

(73) Assignee: Vect'Oeur (Sarl), Savigny Les Beaune (FR)

(21) Appl. No.: 11/658,696

(22) PCT Filed: Jul. 29, 2005
(86) PCT No.: PCT/FR05/01998

§ 371 Date: Jan. 29, 2007

(30) Foreign Application Priority Data
Jul. 30, 2004 (FR) 0408446

(51) Int. Cl. A23L 2/80; B01J 20/26; B01D 15/00; C12H 1/056; B01D 39/16

(52) U.S. Cl. 426/15

(57) ABSTRACT

The invention relates to a method for eliminating toxic or undesirable polyhalogenated compounds from drinks. Said method is characterised in that it comprises a step for bringing the drink into contact with an adsorbent consisting of a synthetic polymer material obtained from a mixture of aliphatic and non-aliphatic monomers. The aim of the invention is especially to eliminate halophenols and haloanisols in wine, with short periods of treatment.

The present invention relates to a method for partly or totally eliminating toxic or undesirable polyhalogenated compounds in drinks and in particular in wine.

In recent years, measures have been regularly taken for restricting or prohibiting the use and marketing of an increasingly large number of chemical compounds, and in particular of pesticides and other treatment products, taking into account their strong toxicity and their effect on the health of consumers.

This is thus the case of pentachlorophenol (PCP), a molecule used as a wood preservation product and as a disinfectant, a herbicide, a termiticide, and an anti-fouling paint. This compound and its degradation or manufacturing byproducts (2,4,6-trichlorophenol (TCP) and 2,3,4,6-tetra-chlorophenol (TeCP)) have strong toxicity for the human organism and animals. Lindane (γ-1,2,3,4,5,6-hexachloro-cyclohexane) is also a toxic compound, the use of which is very widespread as an insecticide, notably for treating soils and wood. Moreover, another polybrominated phenol compound is known, 2,4,6-tribromophenol (TBP) increasingly used as a flame retarder, as a fungicide or wood protection agent. Its toxicity is comparatively less significant than that of PCP or other brominated flame retarders, which themselves have been the subject of prohibitions. Nevertheless, its increasing use will cause a larger exposure of the consumers and, in the name of the precautionary principle, it is therefore important to reduce this exposure as much as possible.

It is well understood that if the restrictive measures concerning the production and use of these polyhalogenated toxic compounds will produce an effect in the short term, the materials treated with these products will subsist however. Further, as it was already possible to observe for example with DDT, significant residual traces of these compounds will be found for many years in products intended to be consumed by humans, because of the stability of these compounds and of their persistence in the food chains. This is all the more important for the wine industry which uses wood vats for making wine: the residing of wine in contaminated vats may be a source of contamination for the wine. Additionally, the applied treatments and the condition of the environment of the vine transplants may also be sources of contamination.

Moreover, in the field of wine, eliminating chloroanisoles is a major problem. These compounds, and in particular 2,4,6-trichloroanisole (TCA), are the main compounds responsible for the corky taste and other bad flavours of wines: their elimination causes disappearance of these bad flavours.

Haloanisoles mainly originate from the methylation of halophenols, a process essentially of microbiological nature. 2,3,4,5,6-tetrachloroanisole (TeCA), pentachloroanisole (PCA) and tribromoanisole (TBA) are therefore also concerned.

It is therefore important to be able to eliminate a maximum amount of these toxic or undesirable polyhalogenated compounds from wines, in order to bring them into compliance with phytosanitary standards, either those in effect or future ones, but also to improve the safety of the consumers and to re-establish the original organoleptic properties of the treated wines.

An additional difficulty is to be taken into account: elimination of these compounds should be carried out without it being detrimental to the organoleptic properties of the treated wines, by avoiding any change in the aromatic pool of the relevant wine. This is absolutely necessary in order to comply with legislations in effect on wine appellations and to obtain approval from the relevant authorities.

Finally, for the same reasons, applying the method should not perturb the wine-making process and be economically reasonable.

Such methods have already been proposed.

Thus, Spanish Patent ES 2,195,784 proposes a method for eliminating chloroanisoles and chlorophenols by soaking a food plastic in the wine to be treated, decanted beforehand in an aseptic container. Preferably, a low density polyethylene film is applied for 1 to 15 days. Similar teaching is provided by South African Patent ZA 2004/0725.

Moreover, American U.S. Pat. No. 4,276,179 discloses a method for removing halogenated hydrocarbons, notably DDT and polychlorinated biphenyls, from aqueous media by putting the liquid to be treated in presence of a polyolefin adsorbent. The adsorbent consists of a polymer selected from homopolymers of ethylene, propylene, polytrimethylbutene, and polymethylpentene, as well as the copolymers of these compounds.

Finally, International Patent Application WO 01/88082 describes a method for suppressing unpleasant flavours of wine by putting it into contact with one or more aliphatic polymers, in particular polyethylene, polypropylene, high density polyethylene, high density polypropylene and preferentially, ultra high density polyethylene, either substituted or not with acid and hydroxide groups. The method consists of filtering the wine on a bed of adsorbent granules, with a very low flow rate (5 mL/min). The TCA content is strongly reduced.

The results of the prior art were verified by the applicant: tests conducted with low density polyethylene (LDPE) provided a reduction of more than fifty percent of the content of the main targeted compounds (PCP, TCP, TCA and lindane) in the treated wines.

The LDPE used during these tests, appears as a film with the thickness of 16/100 millimetres. The contact time was 24 hours and the surface between 6 and 10 m² per hectolitre.

The present invention therefore aims at solving the aforementioned difficulties in a more effective way than the prior art by proposing a method for eliminating toxic or undesirable polyhalogenated compounds from drinks, remarkable in that it includes a step for putting the drink to be treated into contact with an adsorbent consisting of a synthetic polymer material.

The conducted tests were indeed able to demonstrate selective adsorption of the targeted compounds without any perceptible change in the aromatic pool and organoleptic properties of the treated wine.

Other advantages and features will become better apparent from the detailed description which follows.

According to an essential feature of the method according to the invention, the drink to be treated is put into contact with an adsorbent consisting of a synthetic polymer material obtained from a mixture of aliphatic and non-aliphatic monomers.

The polymer material according to the invention may therefore be the result of the copolymerization of at least two types of monomers, as conventionally known, and will therefore be of the alternating, random or block copolymer type, but may also result from subsequent associations of two or more polymers, such as a grafted copolymer, obtained by grafting by chain polymerization of a polymer on a first polymeric substrate, or as the result of the melting of a mixture of particles of aliphatic and non-aliphatic polymers, for example.

In a first alternative, the adsorbent will therefore be a copolymer. The aliphatic monomers will be taken from the group: methylene, ethylene, propylene, butylene, acrylonitrile, methyl methacrylate. Lower alkyls will be preferred. The selection of non-aliphatic monomers will be made among: ethylene terephthalate, ethylene naphthalate, methylene terephthalate, propylene terephthalate, butylene terephthalate.

In a second preferred alternative, the adsorbent will result from the melting of a mixture of particles of aliphatic and non-aliphatic polymers.

The aliphatic polymer will preferably be selected from polyethylene in its different forms: low density polyethylene (LDPE), high density polyethylene, linear low density polyethylene (LLDPE). Polypropylene, polyacrylonitrile, poly(methyl methacrylate) may also be used. Preferably, low density polyethylene (LDPE) will be used.

As for the non-aliphatic chain polymer, i.e., including aromatic groups in a structure, it will be selected from polyesters such as poly(ethylene terephthalate) (PET), poly(ethylene naphthalate) (PEN), poly(methylene terephthalate), poly(propylene terephthalate) (PPT) or poly(butylene terephthalate).

According to a feature of the invention, the proportion of non-aliphatic polymer in the adsorbent varies between 1 and 60%.

Further, for reasons of costs and ease of production, binary compositions will be preferred, i.e., those including one kind of aliphatic polymer and one kind of non-aliphatic polymer. Of course, ternary or quaternary adsorbents combining one or several kinds of aliphatics with at least one kind of non-aliphatic polymer may be applied within the scope of the invention.

The preferred formulations for the adsorbent according to the invention will be selected from the group: LDPE/PET, PP/PET, PP/PPT.

According to another feature of the invention, the adsorbent advantageously has a semi-crystalline structure with a crystallinity level less than 60%, preferably less than 45%. Indeed, the looser the crystalline lattice of the polymer will be, the easier will be the diffusion of the molecules sorbed at its surface into the thickness of the adsorbent, thus allowing more toxic molecules to be eliminated.

According to an important feature of the invention, the adsorbent is brought in contact with the drink to be treated by soaking the former in the latter. For this purpose, the adsorbent will be used preferably as a film. However, the adsorbent may be used as granules, woven fibers, chips, or any other form for soaking and compatible with the produced forms of the polymers used.

Having the adsorbent contact the drink to be treated will preferentially be performed according to a batch mode: indeed, it is primordial not to subject the liquid to be treated and in particularly in the case of wine, to stirring or flowing capable of degrading its organoleptic properties. Of course, a device will however be provided with which the whole liquid may be homogenized in order to optimize the effectiveness of the method.

The total surface of the adsorbent to be brought in contact, as well as the duration of the contact, may easily be optimized by the one skilled in the art depending on the initial content of toxic compounds in the drink to be treated.

The table hereafter groups the results of a series of comparative measurements dealing with eliminating PCP over time in wine. The values are the PCP content in ng·L⁻¹.

The adsorbents according to the invention tested in these tests were obtained by mixing granules of the polymers, followed by melting in order to obtain a homogeneous material.

TIME (day)

| | 0 | 1 | 3 | 4 |
|---|---|---|---|---|
| PET 100% | 520.8 | 308.6 | 328.6 | 333.9 |
| 50% PET + 50% LDPE | 520.8 | 51.9 | 35.6 | 28.9 |
| 10% PET + 90% LDPE | 520.8 | 106.3 | 49.4 | 42.2 |
| 2% PET + 98% LDPE | 520.8 | 123 | 56.4 | 36.9 |
| LDPE 100% | 520.8 | 70.6 | 57.4 | 47.5 |

The rise in PCP content observed with PET may be explained by a salting-out phenomenon of the compound in the treated medium.

Measurements conducted in parallel have demonstrated a lowering of the contents of the other targeted compounds (TeCP, TCP, PCA, TeCA, TCA and lindane).

Other tests with an adsorbent with a 10% PET+90% PP formulation, obtained by melting the mixed particles, conducted on naturally TCA-contaminated wines (TCA content varying between 9 and 20 g/L), have demonstrated the effectiveness of this formulation to rapidly adsorb TCA, with which the corky taste may disappear upon tasting, after contacting times, by simple soaking, varying between 20 minutes and 2 hours 30 minutes depending on the wines. Additionally, the contents of the different aromatic compounds of the wine have not been changed or only a little changed, in any case, not in an organoleptically perceptible way during tasting. Further, no trace of contamination of the wine by compounds stemming from the adsorbent was reported.

1-9. (canceled)

10. A method for eliminating in wine, toxic or undesirable polyhalogenated compounds, taken from the group pentachlorophenol, 2,3,4,6-tetrachlorophenol, 2,4,6-trichlorophenol, 2,4,6-tribromophenol, pentachloro-anisole, 2,3,4,6-tetrachloroanisole, 2,4,6-trichloroanisole, 2,4,6-tribromoanisole, lindane, without being detrimental to the organoleptic properties of the treated wines, characterized in that said method includes a step of bringing the drink to be treated in contact with an adsorbent which is a food grade copolymer of aliphatic and non-aliphatic monomers, the aliphatic monomers being selected from: methylene, ethylene, propylene, butylene, acrylonitrile, methyl methacrylate, and the non-aliphatic monomers are taken from: ethylene terephthalate, ethylene naphthalate, methylene terephthalate, propylene terephthalate, butylene terephthalate.

11. The method according to claim 10, characterized in that the proportion of non-aliphatic polymer in the adsorbent varies between 1 and 60%.

12. The method according to claim 10, characterized in that the formulation of the adsorbent is selected from the group: LDPE/PET, PP/PET, PP/PPT.

13. The method according to claim 10, characterized in that the adsorbent has a semi-crystalline structure with a degree of crystallinity less than 60%, preferably less than 45%.

14. The method according to claim 10, characterized in that the contacting is performed by soaking the adsorbent in the wine to be treated, according to a batch mode.

15. A method for eliminating in wine, toxic or undesirable polyhalogenated compounds, taken from the group pentachlorophenol, 2,3,4,6-tetrachlorophenol, 2,4,6-trichloro-phenol, 2,4,6-tribromophenol, pentachloro-anisole, 2,3,4,6-tetrachloroanisole, 2,4,6-trichloroanisole, 2,4,6-tribromoanisole, lindane, without being detrimental to the organoleptic properties of the treated wines, characterized in that said method includes a step of bringing the drink to be treated in contact with an adsorbent consisting of a synthetic polymeric material obtained from melting a mixture of particles of food grade aliphatic and non-aliphatic polymers, the aliphatic polymer being selected from the group: low density polyethylene, high density polyethylene, linear low density polyethylene, polypropylene, polyacrylonitrile, poly(methyl methacrylate), and the non-aliphatic chain polymer being selected from the group: poly(ethylene terephthale), poly(ethylene naphthalate), poly(methylene terephthalate), poly(propylene terephthalate), poly(butylene terephthalate).

16. The method according to claim 15, characterized in that the proportion of non-aliphatic polymer in the adsorbent varies between 1 and 60%.

17. The method according to claim 15, characterized in that the formulation of the adsorbent is selected from the group: LDPE/PET, PP/PET, PP/PPT.

18. The method according to claim 15, characterized in that the adsorbent has a semi-crystalline structure with a degree of crystallinity less than 60%, preferably less than 45%.

19. The method according to claim 15, characterized in that the contacting is performed by soaking the adsorbent in the wine to be treated, according to a batch mode.
